(19) United States
(12) Patent Application Publication
(10) Pub. No.: US 2025/0037183 A1
(43) Pub. Date: Jan. 30, 2025

(54) SYSTEM AND METHOD FOR RECOMMENDING ITEMS TO CREATE ADVERTISING CAMPAIGNS FOR UPCOMING EVENTS

(71) Applicant: Walmart Apollo, LLC, Bentonville, AR (US)

(72) Inventor: Omker Mahalanobish, Nayabad (IN)

(21) Appl. No.: 18/359,771

(22) Filed: Jul. 26, 2023

(51) Int. Cl. G06Q 30/0601; G06Q 10/087; G06Q 30/0241

(52) U.S. Cl. CPC G06Q 30/0631; G06Q 10/087; G06Q 30/0276

(57) ABSTRACT

Systems and methods for recommending items to create advertising campaigns for upcoming events are disclosed. In some embodiments, a disclosed method comprises: identifying at least one upcoming shopping event; determining, based on a machine learning model generated irrespective of any shopping event, a plurality of item-seller combinations each formed by a respective item and a respective seller; performing an allocation of at least one of the item-seller combinations to the at least one upcoming shopping event; generating, for a seller, a customized list of items associated with the at least one upcoming shopping event based on the allocation; and transmitting the customized list of items for the seller to create an advertising campaign.

### TECHNICAL FIELD

This application relates generally to advertising campaigns and, more particularly, to systems and methods for recommending items to create advertising campaigns for upcoming events.

### BACKGROUND

An advertisement may be a presentation or communication to promote an item, such as a product or service, for purchase. At least some advertisements are digital advertisements, which include a digital representation of the presentation or communication, such as one displayed on a website. A sponsor of an advertisement, such as a business, may seek to sell the item in the advertisement. The sponsor may advertise the item in the advertisement to notify potential buyers of the sale of the item, thereby increasing the chances of selling the item. For example, the sponsor may advertise the item on a website, such as a retailer's website.

In at least some examples, the advertisement may be part of an advertising campaign that identifies one or more products to promote on the website. An advertising campaign could be either a specific theme-based campaign for a theme like Back to School, Valentine's Day, Christmas, etc.; or in form of a weekly Flash Pick event, which pertains to a generic theme of evergreen deals. A seller can submit selected items from an assortment for each of these campaigns to an online retailer, which can approve or reject the submitted items for campaign creation. But existing sellers manually select the items to submit for campaign creation, and are mostly overwhelmed by their vast assortments while only a limited number of item submissions per event is allowed.

### SUMMARY

The embodiments described herein are directed to systems and methods for recommending items to create advertising campaigns for upcoming events.

In various embodiments, a system including a non-transitory memory configured to store instructions thereon and at least one processor is disclosed. The at least one processor is configured to read the instructions to: identify at least one upcoming shopping event in a future time period; determine, based on a machine learning model generated irrespective of any shopping event, a plurality of item-seller combinations formed by: (a) a plurality of sellers of an online marketplace and (b) a plurality of items being sold on the online marketplace, wherein each of the plurality of item-seller combinations identifies an item whose sale probability by a corresponding seller in the future time period is larger than a threshold; perform an allocation of at least one of the plurality of item-seller combinations to each of the at least one upcoming shopping event; generate, for each of the plurality of sellers, a customized list of items for each upcoming shopping event based on the allocation; and transmit, to a computing device of each of the plurality of sellers, the customized list of items for creating advertising campaigns associated with the at least one upcoming shopping event.

In various embodiments, a computer-implemented method is disclosed. The computer-implemented method includes: identifying at least one upcoming shopping event in a future time period; determining, based on a machine learning model generated irrespective of any shopping event, a plurality of item-seller combinations formed by: (a) a plurality of sellers of an online marketplace and (b) a plurality of items being sold on the online marketplace, wherein each of the plurality of item-seller combinations identifies an item whose sale probability by a corresponding seller in the future time period is larger than a threshold; performing an allocation of at least one of the plurality of item-seller combinations to each of the at least one upcoming shopping event; generating, for each of the plurality of sellers, a customized list of items for each upcoming shopping event based on the allocation; and transmitting, to a computing device of each of the plurality of sellers, the customized list of items for creating advertising campaigns associated with the at least one upcoming shopping event.

In various embodiments, a non-transitory computer readable medium having instructions stored thereon is disclosed. The instructions, when executed by at least one processor, cause at least one device to perform operations including: identifying at least one upcoming shopping event in a future time period; determining, based on a machine learning model generated irrespective of any shopping event, a plurality of item-seller combinations formed by: (a) a plurality of sellers of an online marketplace and (b) a plurality of items being sold on the online marketplace, wherein each of the plurality of item-seller combinations identifies an item whose sale probability by a corresponding seller in the future time period is larger than a threshold; performing an allocation of at least one of the plurality of item-seller combinations to each of the at least one upcoming shopping event; generating, for each of the plurality of sellers, a customized list of items for each upcoming shopping event based on the allocation; and transmitting, to a computing device of each of the plurality of sellers, the customized list of items for creating advertising campaigns associated with the at least one upcoming shopping event.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to recommend items to create advertising campaigns for upcoming events, in accordance with some embodiments of the present teaching.

FIG. 2 is a block diagram of a campaign recommendation computing device, in accordance with some embodiments of the present teaching.

FIG. 3 is a block diagram illustrating various portions of a system for recommending items to create advertising campaigns for upcoming events, in accordance with some embodiments of the present teaching.

FIG. 4 is a block diagram illustrating various portions of a campaign recommendation computing device, in accordance with some embodiments of the present teaching.

FIG. 5 illustrates a data architecture for preparing data to build a machine learning model, in accordance with some embodiments of the present teaching.

FIG. 6 illustrates an exemplary diagram of a recommendation model, in accordance with some embodiments of the present teaching.

FIG. 7A illustrates an exemplary architecture of a stage-1 recommendation model, in accordance with some embodiments of the present teaching.

FIG. 7B illustrates an exemplary architecture of a stage-2 recommendation model, in accordance with some embodiments of the present teaching.

FIG. 8 illustrates a process for campaign allocation, in accordance with some embodiments of the present teaching.

FIG. 9 illustrates an exemplary user interface to create advertising campaigns, in accordance with some embodiments of the present teaching.

FIG. 10 illustrates an exemplary user interface for recommending items to create advertising campaigns, in accordance with some embodiments of the present teaching.

FIG. 11 is a flowchart illustrating an exemplary method for recommending items to create advertising campaigns for upcoming events, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

An online marketplace or retailer may create and run advertising campaigns via a seller's portal from time to time. Each advertising campaign may be associated with a holiday, a shopping season, or a discount event. Seller partners of the online marketplace may submit items for each campaign. Once a submission is approved, it can become part of the event. Since sellers can only make a limited number of submission per event, it becomes utmost important for a seller to be able to correctly choose which items to submit.

One goal of the present teaching is to use a suite of machine learning models to provide each seller a good starting point for creating an advertising campaign, e.g. by recommending a customized list of items from the seller's assortment to appropriately fit for an upcoming event. The recommendation list provided to the seller is best suited to sell well in the event period and is also curated to pass through an approval process of the online retailer with a high probability.

In some embodiments, a campaign agnostic model is developed and used to select items for any upcoming campaign, irrespective of the theme, duration, and timeline of the campaign. That is, the items selected by the campaign agnostic model are not dependent on the theme, duration, and timeline of the upcoming campaign.

In some embodiments, the campaign agnostic model comprises two stages: a stage-1 model for item level recommendation, and a stage-2 model for stock keeping unit (SKU) level recommendation. Each SKU corresponds to a combination of an item and a seller. The output of the stage-1 model may be utilized as an input of the stage-2 model. The items identified using the campaign agnostic model may be input into a recommender.

While the campaign agnostic model is agnostic of the campaign, the recommender adds campaign level customization along with overall curation and optimization to the recommendations, to provide item recommendations to sellers at a personalized level for campaign submission and creation. In some embodiments, the recommender may include a campaign allocation model configured to allocate items selected by the campaign agnostic model to each of eligible upcoming events based on the event and campaign themes, and include an optimization model configured to perform a series of seller-level optimization operations to generate personalized recommendations.

Furthermore, in the following, various embodiments are described with respect to methods and systems for recommending items to create advertising campaigns for upcoming events are disclosed. In some embodiments, based on a machine learning model generated irrespective of any shopping event, a plurality of item-seller combinations is formed by: (a) a plurality of sellers of an online marketplace and (b) a plurality of items being sold on the online marketplace. Each item-seller combination identifies an item whose sale probability by a corresponding seller in a future time period is larger than a threshold. At least one item-seller combination is allocated to each upcoming shopping event. For each of the plurality of sellers, a customized list of items is generated for each upcoming shopping event based on the allocation, and transmitted to a computing device of each of the plurality of sellers for creating advertising campaigns associated with the upcoming shopping event.

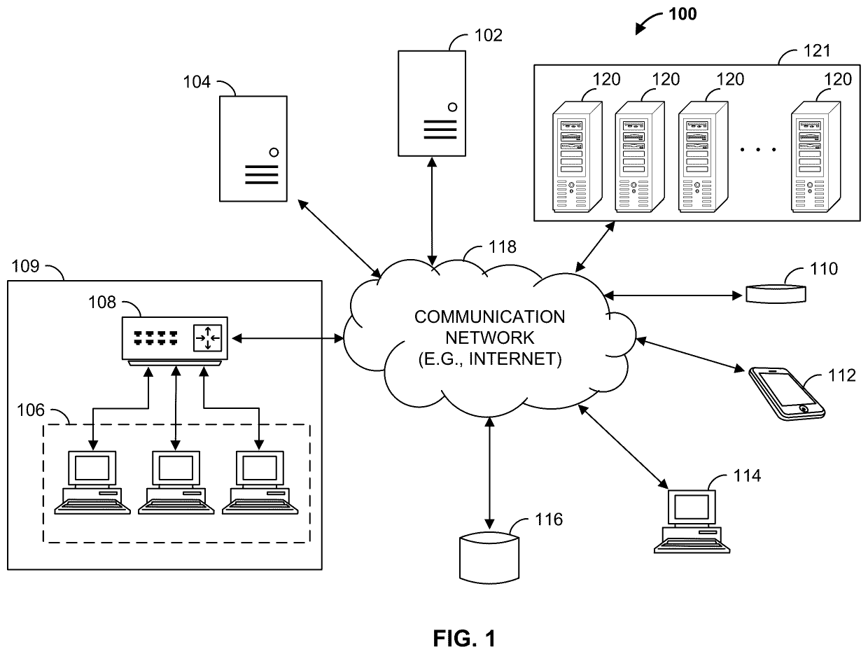

Turning to the drawings, FIG. 1 is a network environment 100 configured to recommend items to create advertising campaigns for upcoming events, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a campaign recommendation computing device 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The campaign recommendation computing device 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the campaign recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the campaign recommendation computing device 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the campaign recommendation computing device 102, the processing devices 120, and/or the web server 104 are operated by a retailer. The multiple user computing devices 110, 112, 114 may be operated by customers and advertisers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the campaign recommendation computing device 102 over the communication network 118. The workstation(s) 106 may send data to, and receive data from, the campaign recommendation computing device 102. For example, the workstation(s) 106 may transmit data identifying items purchased by a customer at the store 109 to the campaign recommendation computing device 102.

Although FIG. 1 illustrates three user computing devices 110, 112, 114, the network environment 100 can include any number of user computing devices 110, 112, 114. Similarly, the network environment 100 can include any number of the campaign recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view item advertisements for items displayed on the website, and may click on item advertisements, for example. The website may capture these activities as user session data, and transmit the user session data to the campaign recommendation computing device 102 over the communication network 118. The website may also allow the customer to add one or more of the items to an online shopping cart, and allow the customer to perform a “checkout” of the shopping cart to purchase the items. In some examples, the web server 104 transmits purchase data identifying items the customer has purchased from the website to the campaign recommendation computing device 102.

In some examples, an advertiser or a sponsor of advertisement, e.g., an online seller, may operate one of the user computing devices 110, 112, 114 to initiate a web browser or a user interface that is associated with a website hosted by the web server 104. The advertiser may, via the web browser or the user interface, view item sets sold by the seller on the website, view and manage existing campaigns for some item sets sold by the seller, view items recommended by the retailer based on machine learning models to create new campaigns for upcoming events, and/or create a new campaign including an item set sold by the seller. The website may capture at least some of these activities as campaign data. The web server 104 may transmit the campaign data to the campaign recommendation computing device 102 over the communication network 118, and/or store the campaign data to the database 116.

In some embodiments, the web server 104 may transmit a recommendation request to the campaign recommendation computing device 102, e.g. upon a selection of an advertiser to run the campaign recommendation or upon a pre-configured periodic recommendation job. The recommendation request may be sent standalone or together with campaign related data of the website. In some examples, the recommendation request may carry or indicate campaign data of a proposed campaign for at least one upcoming event in a future time period on the website. In some examples, the recommendation request may also carry or indicate historical campaign data of previous campaigns on the website.

In some examples, the campaign recommendation computing device 102 may execute one or more models (e.g., algorithms), such as a machine learning model, deep learning model, statistical model, etc., to determine recommended items for a seller to add into an advertising campaign. The campaign recommendation computing device 102 may first determine a plurality of item-seller combinations that are likely to sell well in a future time period. For example, each item-seller combination corresponds to an item and a corresponding seller such that a sale probability of the item by the corresponding seller in the future time period is larger than a threshold. The campaign recommendation computing device 102 may allocate at least one of the plurality of item-seller combinations to each upcoming shopping event, and perform some customized optimization to generate a customized list of items for each seller and each upcoming shopping event. The campaign recommendation computing device 102 may then transmit to a computing device of each seller the customized list of items for creating advertising campaigns associated with the corresponding upcoming shopping event.

The campaign recommendation computing device 102 is further operable to communicate with the database 116 over the communication network 118. For example, the campaign recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the campaign recommendation computing device 102, in some examples, the database 116 can be a local storage device, such as a hard drive, a non-volatile memory, or a USB stick. The campaign recommendation computing device 102 may store online purchase data received from the web server 104 in the database 116. The campaign recommendation computing device 102 may receive in-store purchase data from different stores 109 and store them in the database 116. The campaign recommendation computing device 102 may also receive from the web server 104 user session data identifying events associated with browsing sessions, and may store the user session data in the database 116. The campaign recommendation computing device 102 may also determine item-seller recommendations in response to a recommendation request received from the web server 104, and may store data related to the item-seller recommendations in the database 116.

In some examples, the campaign recommendation computing device 102 generates training data for a plurality of models (e.g., machine learning models, deep learning models, statistical models, algorithms, etc.) based on: e.g. historical customer session data, search data, purchase data, catalog data, campaign data, advertisement data, cluster data, item features, seller features, etc. The campaign recommendation computing device 102 trains the models based on their corresponding training data, and stores the models in a database, such as in the database 116 (e.g., a cloud storage).

The models, when executed by the campaign recommendation computing device 102, allow the campaign recommendation computing device 102 to determine recommended items for sellers to create advertising campaigns. In some examples, the campaign recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the campaign recommendation computing device 102 may generate item recommendations for sellers to submit the recommended items for upcoming advertising campaigns in view of upcoming events.

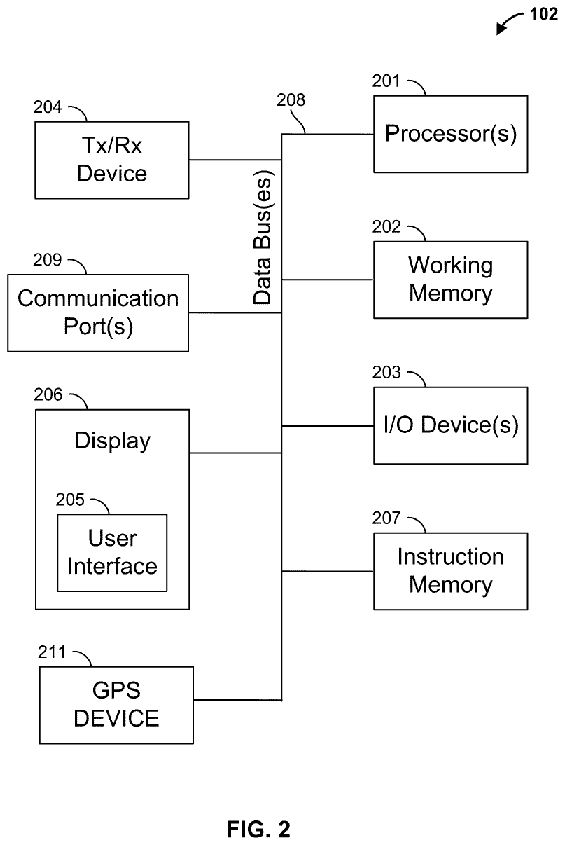

FIG. 2 illustrates a block diagram of a campaign recommendation computing device, e.g. the campaign recommendation computing device 102 of FIG. 1, in accordance with some embodiments of the present teaching. In some embodiments, each of the campaign recommendation computing device 102, the web server 104, the workstation(s) 106, the multiple user computing devices 110, 112, 114, and the one or more processing devices 120 in FIG. 1 may include the features shown in FIG. 2. Although FIG. 2 is described with respect to the campaign recommendation computing device 102. It should be appreciated, however, that the elements described can be included, as applicable, in any of the campaign recommendation computing device 102, the web server 104, the workstation(s) 106, the multiple user computing devices 110, 112, 114, and the one or more processing devices 120.

As shown in FIG. 2, the campaign recommendation computing device 102 can include one or more processors 201, a working memory 202, one or more input/output devices 203, an instruction memory 207, a transceiver 204, one or more communication ports 209, a display 206 with a user interface 205, and an optional global positioning system (GPS) device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 207 can store instructions that can be accessed (e.g., read) and executed by the processors 201. For example, the instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 207, embodying the function or operation. For example, the processors 201 can be configured to execute code stored in the instruction memory 207 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 207. The processors 201 can also use the working memory 202 to store dynamic data created during the operation of the campaign recommendation computing device 102. The working memory 202 can be a random access memory (RAM) such as a static random access memory (SRAM) or dynamic random access memory (DRAM), or any other suitable memory.

The input-output devices 203 can include any suitable device that allows for data input or output. For example, the input-output devices 203 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 207. In some examples, the communication port(s) 209 allow for the transfer (e.g., uploading or downloading) of data, such as machine learning model training data.

The display 206 can be any suitable display, and may display the user interface 205. The user interfaces 205 can enable user interaction with the campaign recommendation computing device 102. For example, the user interface 205 can be a user interface for an application of a retailer that allows a customer to view and interact with a retailer's website. In some examples, a user can interact with the user interface 205 by engaging the input-output devices 203. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the campaign recommendation computing device 102 will be operating in. The processor(s) 201 is operable to receive data from, or send data to, a network, such as the communication network 118 of FIG. 1, via the transceiver 204.

The optional GPS device 211 may be communicatively coupled to the GPS and operable to receive position data from the GPS. For example, the GPS device 211 may receive position data identifying a latitude, and longitude, from a satellite of the GPS. Based on the position data, the campaign recommendation computing device 102 may determine a local geographical area (e.g., town, city, state, etc.) of its position. Based on the geographical area, the campaign recommendation computing device 102 may determine relevant trend data (e.g., trend data identifying events in the geographical area).

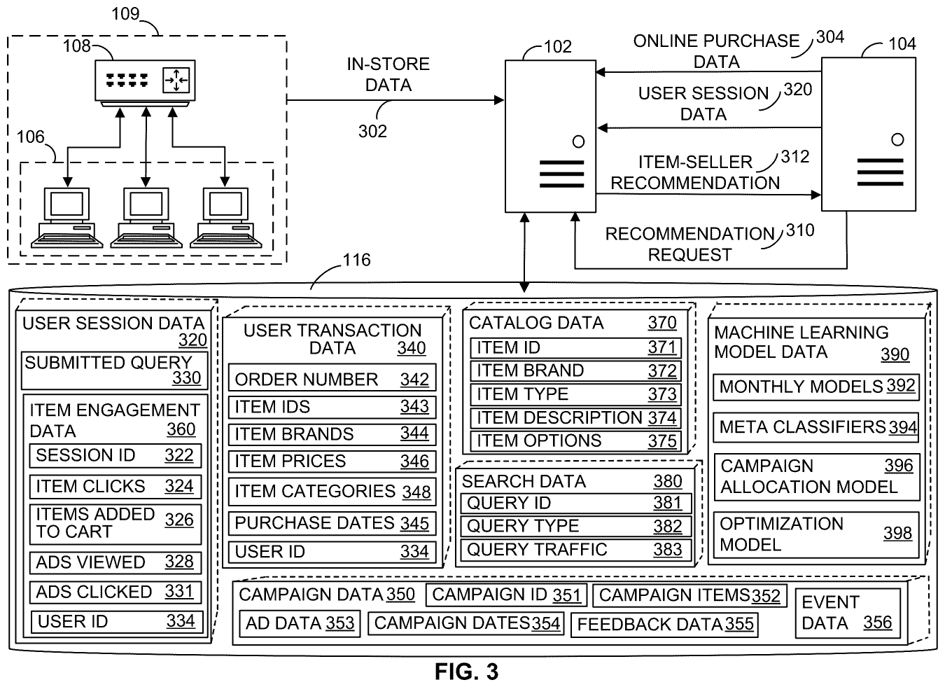

FIG. 3 is a block diagram illustrating various portions of a system for recommending items to create advertising campaigns for upcoming events, e.g. the system shown in the network environment 100 of FIG. 1, in accordance with some embodiments of the present teaching. As indicated in FIG. 3, the campaign recommendation computing device 102 may receive user session data 320 from the web server 104, and store the user session data 320 in the database 116. The user session data 320 may identify, for each user (e.g., customer), data related to that user's browsing session, such as when browsing a retailer's webpage hosted by the web server 104.

In some examples, the user session data 320 may include item engagement data 360 and/or submitted query data 330. The item engagement data 360 may include one or more of a session ID 322 (i.e., a website browsing session identifier), item clicks 324 identifying items which a user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 331 identifying advertisements the user clicked on, and user ID 334 (e.g., a customer ID, retailer website login ID, a cookie ID, etc.). The submitted query data 330 may identify one or more searches conducted by a user during a browsing session (e.g., a current browsing session).

The campaign recommendation computing device 102 may also receive online purchase data 304 from the web server 104, which identifies and characterizes one or more online purchases, such as purchases made by the user and other users via a retailer's website hosted by the web server 104. The campaign recommendation computing device 102 may also receive in-store data 302 from the store 109, which identifies and characterizes one or more in-store purchases, in-store advertisements, in-store shopping data, etc. In some embodiments, the in-store data 302 may also indicate availability of items in the store 109, and/or user IDs that have selected the store 109 as a default store for picking up online orders.

The campaign recommendation computing device 102 may parse the in-store data 302 and the online purchase data 304 to generate user transaction data 340. In this example, the user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item categories 348 identifying a category of each item purchased, a purchase date 345 identifying the purchase date of the purchase order, and user ID 334 for the user making the corresponding purchase.

The database 116 may further store catalog data 370, which may identify one or more attributes of a plurality of items, such as a portion of or all items a retailer carries. The catalog data 370 may identify, for each of the plurality of items, an item ID 371 (e.g., an SKU number), item brand 372, item type 373 (e.g., a product type like grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store search data 380, which may identify one or more attributes of a plurality of queries submitted by users on the website hosted by the web server 104 and/or on a website of a search engine hosted by the search engine server 190. The search data 380 may include, for each of the plurality of queries, a query ID 381 identifying a query previously submitted by users, a query type 382 (e.g., a head query, a torso query, or a tail query), and query traffic data 383 identifying how many times the query has been submitted or how many clicks the query has received.

In some embodiments, the database 116 may further store campaign data 350, which may identify data of one or more advertising campaigns proposed and/or created for the retailer's website hosted by the web server 104. The campaign data 350 may identify, for each campaign, campaign ID 351 identifying the campaign, campaign items 352 identifying items promoted by the campaign, advertisement data 353 identifying advertisements included in the campaign, campaign dates 354 identifying the start and end dates of the campaign, feedback data 355 identifying customer and seller feedbacks regarding items promoted by the campaign, and event data 356 identifying events and/or shopping seasons associated with the campaign. In some examples, the feedback data 355 may identify customers' ratings, reviews, returns and cancellations for the promoted items, sellers' on-time delivery rate, sellers ratings, etc.

The database 116 may also store machine learning model data 390 identifying and characterizing one or more machine learning models and related data for recommending items. For example, the machine learning model data 390 may include monthly models 392, meta classifiers 394, a campaign allocation model 396, and an optimization model 398.

In some embodiments, the monthly models 392 may be used to determine recommended campaign items for each month. The monthly models 392 may be trained based on item and/or seller features, periodically every month. For example, the monthly models 392 may comprise 12 models: a model for January, a model for February, . . . a model for December. Each monthly model may be generated based on features and data from a corresponding month. Since many business and personal shopping activities may repeat year over year, for the same month, separately training different monthly models can give a good prediction for sale probability of items in a future campaign.

The meta classifiers 394 may be used to generate aggregated item recommendations based on recommendations from all of the monthly models 392. In some embodiments, there are multiple meta classifiers 394 each located in a different stage of a multi-stage machine learning model, where each stage includes the monthly models 392 and a corresponding meta classifier 394. In some embodiments, a meta classifier 394 is trained to determine optimal weights to combine different monthly models 392. In some embodiments, the meta classifiers 394 and the monthly models 392 can be trained together using historical campaign data and performance.

In some embodiments, all of the monthly models 392 and the meta classifiers 394 are campaign agnostic. That is, the monthly models 392 and the meta classifiers 394 do not need to know information about a specific campaign with a specific theme in a future time period. The operations of the monthly models 392 and the meta classifiers 394 do not depend on the campaign information. For example, the monthly models 392 and the meta classifiers 394 will operate irrespective of whether there is one or more holidays in an upcoming month and regardless of what are the themes associated with the holidays, which sellers will receive these recommendations, etc.

The campaign allocation model 396 may be used to allocate items recommended by the monthly models 392 and the meta classifiers 394 to different eligible events in a future time period. For example, if there are multiple events in next month, e.g. Memorial Day and Mother's Day, the campaign allocation model 396 can be used to allocate different items to different events, based on each event's themes and each item's features. For example, a jewelry would be allocated to Mother's Day, while a BBQ grill would be allocated to Memorial Day.

Thus, different items will be recommended to different campaigns associated with different events.

Based on the campaign level recommendations generated using the campaign allocation model 396, the optimization model 398 may be used to perform optimizations based on pre-determined constraints. For example, the optimizations may include a seller-level optimization to generate customized recommendation for each seller, so that different sellers will get different recommended items customized based on each respective seller's profile. In addition, the optimization model 398 may be used to perform other optimizations like price competitive optimization, minimization of likelihood to be rejected by the retailer, quality optimization in terms of performance, reviews, ratings, shipping speed, etc.

In some examples, the campaign recommendation computing device 102 receives (e.g., in real-time) from the web server 104, a recommendation request 310 seeking items to be recommended to sellers for creating advertising campaigns to be run in a future time period. In response, the device 102 generates item-seller recommendation 312 identifying recommended items for each seller at the level of item-seller combination (e.g. at the level of SKU), and transmits the item-seller recommendation 312 to the web server 104. In some examples, the item-seller recommendation 312 includes a customized list of items for each upcoming shopping event and each seller. Each customized list of items may be transmitted to a corresponding seller by the campaign recommendation computing device 102 or the web server 104. The customized list of items will be utilized by the corresponding seller to create advertising campaigns associated with upcoming shopping events in the future time period.

In some embodiments, the campaign recommendation computing device 102 may assign one or more of the operations described above to a different processing unit or virtual machine hosted by the one or more processing devices 120. Further, the campaign recommendation computing device 102 may obtain the outputs of the these assigned operations from the processing units, and generate the item-seller recommendation 312 based on the outputs.

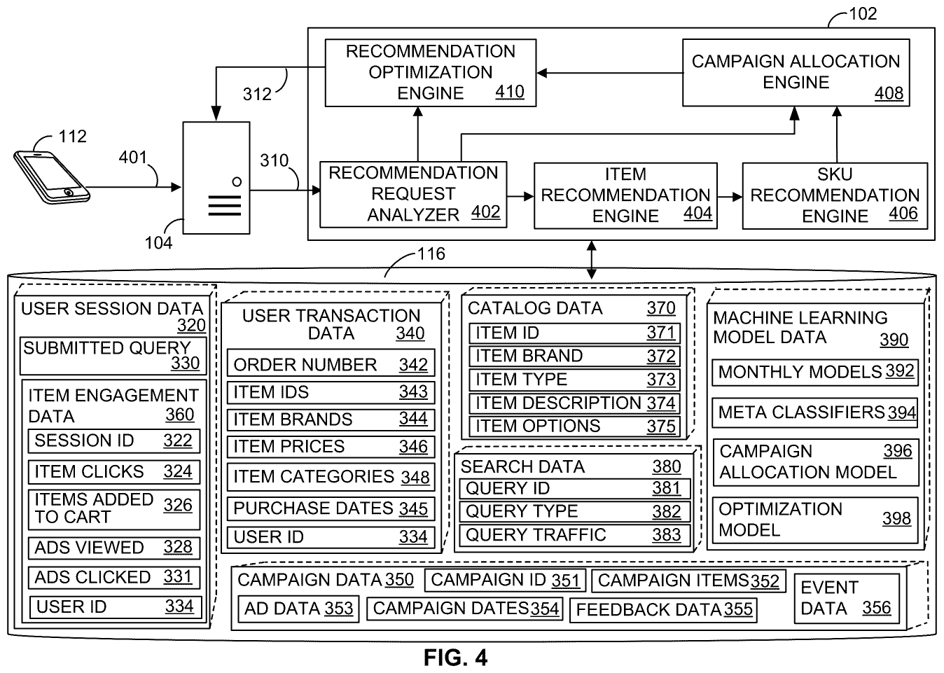

FIG. 4 is a block diagram illustrating various portions of a campaign recommendation computing device, e.g. the campaign recommendation computing device 102 in FIG. 1, in accordance with some embodiments of the present teaching. As shown in FIG. 4, the campaign recommendation computing device 102 includes a recommendation request analyzer 402, an item recommendation engine 404, an SKU recommendation engine 406, a campaign allocation engine 408, and a recommendation optimization engine 410. In some examples, one or more of the recommendation request analyzer 402, the item recommendation engine 404, the SKU recommendation engine 406, the campaign allocation engine 408, and the recommendation optimization engine 410 are implemented in hardware. In some examples, one or more of the recommendation request analyzer 402, the item recommendation engine 404, the SKU recommendation engine 406, the campaign allocation engine 408, and the recommendation optimization engine 410 are implemented as an executable program maintained in a tangible, non-transitory memory, such as instruction memory 207 of FIG. 2, which may be executed by one or processors, such as the processor 201 of FIG. 2.

For example, the recommendation request analyzer 402 may obtain from the web server 104 a recommendation request 310 as a message 401 is sent from the user device 112 to the web server 104, e.g. as a seller logs in an account on a retailer's website via the user computing device 112, as a seller clicks on the retailer's website via the user computing device 112 to request item recommendations for upcoming advertising campaigns. In some embodiments, the recommendation request analyzer 402 may obtain the recommendation request 310 periodically, based on a pre-configuration, e.g. every week, every two weeks, or every month. The recommendation request analyzer 402 may analyze the recommendation request 310 to determine a future time period in which the upcoming advertising campaigns will be run, and identify at least one upcoming shopping event in the future time period. In addition, the recommendation request analyzer 402 may obtain campaign related data, item related data and seller related data associated with the recommendation request 310, e.g. by parsing the user transaction data 340, the catalog data 370, the search data 380, and/or the campaign data 350 in the database 116. The recommendation request analyzer 402 may send the item related data to the item recommendation engine 404 for item recommendation, and send the item and seller related data to the SKU recommendation engine 406 for SKU recommendation. The recommendation request analyzer 402 may send campaign related data to the campaign allocation engine 408 for campaign allocation, and send optimization related data to the recommendation optimization engine 410 for recommendation optimization.

In some embodiments, the item recommendation engine 404 can determine recommended items for the future time period, based on a first stage model. In some examples, each recommended item determined based on the first stage model has a sale probability larger than a first threshold in the future time period. In various examples, the sale probability means a probability to have a sale volume larger than a certain threshold, a probability to have a sale revenue larger than a certain threshold, a probability to have a sale increase compared to previous time period, e.g. larger than 10% increase compared to last week, last month or the same month last year.

In some embodiments, the first stage model in a machine learning model comprising twelve monthly first stage models and a first meta classifier. Each monthly first stage model may be a monthly model 392 configured to: compute a first sale probability for each item based on a first feature set, and determine first feature importance data associated with features in the first feature set. The first feature set may comprise at least some of the following features related to each item: the item's hierarchy, ratings, reviews, relative sales performance, absolute sales performance, return rates, and pageviews. The first meta classifier may be one of the meta classifiers 394 and configured to: determine, for each item, first weights for the twelve monthly first stage models, based on their respective first sale probabilities and their respective first feature importance data, and compute a first stage probability for each item based on a weighted combination of the first sale probabilities of the twelve monthly first stage models, with their respective first weights.

In some embodiments, each of the twelve monthly first stage models comprises: a first classifier configured to compute a first sale probability for each item based on first feature importance data associated with features of the item; a second classifier configured to compute a second sale probability for each item based on second feature importance data associated with features of the item; and a third classifier configured to compute a third sale probability for each item based on third feature importance data associated with features of the item. The first classifier may be trained based on a first feature set that comprises at least some of the following features related to each item: the item's hierarchy, ratings, reviews, relative sales performance, absolute sales performance, return rates, and pageviews. The second classifier may be trained based on the first feature set with higher weights on positive observations. The third classifier may be trained based on the first feature set with higher weights on negative observations. The first meta classifier may comprises: a first aggregated classifier configured to compute a first aggregated sale probability for each item based on a weighted combination of the first sale probabilities of the first classifiers in the twelve monthly first stage models; a second aggregated classifier configured to compute a second aggregated sale probability for each item based on a weighted combination of the second sale probabilities of the second classifiers in the twelve monthly first stage models; a third aggregated classifier configured to compute a third aggregated sale probability for each item based on a weighted combination of the third sale probabilities of the third classifiers in the twelve monthly first stage models; and a first optimizer. The first aggregated classifier may be trained based on a portion of most important item features indicated by the first feature importance data. The second aggregated classifier may be trained based on a portion of most important item features indicated by the second feature importance data. The third aggregated classifier may be trained based on a portion of most important item features indicated by the third feature importance data. The first optimizer is configured to: determine, for each item, first weights for the first aggregated sale probability, the second aggregated sale probability and the third aggregated sale probability; and compute a first stage probability for each item based on a weighted combination of the first aggregated sale probability, the second aggregated sale probability and the third aggregated sale probability, with their respective first weights. In some examples, the first weights can maximize an F-score that is computed based on a combination of a precision rate and a recall rate of item sale prediction. That is, maximizing the F-score is a good tradeoff point to maximize the precision rate and the recall rate.

In some embodiments, the item recommendation engine 404 may send the first stage probability to the SKU recommendation engine 406 for determining a plurality of item-seller combinations formed by: (a) a plurality of sellers of an online marketplace and (b) a plurality of items being sold on the online marketplace. Each of the plurality of item-seller combinations identifies an item whose sale probability by a corresponding seller in the future time period is larger than a threshold. In some examples, the SKU recommendation engine 406 recommend SKUs based a second stage model. Each SKU corresponds to a combination of an item and a corresponding seller. The second stage model may comprise twelve monthly second stage models and a second meta classifier. For each of the determined items from the item recommendation engine 404, the SKU recommendation engine 406 can determine, based on the second stage model, at least one seller who is expected to sell the item with a probability larger than a second threshold in the future time period.

In some embodiments, each of the twelve monthly second stage models is a monthly model 392 configured to: compute, based on a second feature set, a second sale probability for each SKU corresponding to an item-seller combination; and determine second feature importance data associated with features in the second feature set. The second feature set may comprise at least some of the following features related to each SKU: hierarchy, ratings, reviews, relative sales performance, absolute sales performance, returns, cancellations, pageviews, seller's on-time delivery rate, seller's ratings, SKU's listing quality, SKU's price in comparison to competitors, and whether the SKU has a buy box. The second meta classifier may be one of the meta classifiers 394 and configured to: determine, for each SKU, second weights for the twelve monthly second stage models, based on their respective second sale probabilities and their respective second feature importance data; and compute a second stage probability for each SKU based on a combination of: (a) the first stage probability for an item corresponding to the SKU, and (b) a weighted combination of the second sale probabilities of the twelve monthly second stage models with their respective second weights.

In some embodiments, each of the twelve monthly second stage models comprises: a fourth classifier configured to compute a fourth sale probability for each stock keeping unit (SKU) corresponding to an item-seller combination based on fourth feature importance data associated with features of the SKU; a fifth classifier configured to compute a fifth sale probability for each SKU based on fifth feature importance data associated with features of the SKU; and a sixth classifier configured to compute a sixth sale probability for each SKU based on sixth feature importance data associated with features of the SKU. The fourth classifier may be trained based on a second feature set that comprises at least some of the following features related to each SKU: hierarchy, ratings, reviews, relative sales performance, absolute sales performance, returns, cancellations, pageviews, seller's on-time delivery rate, seller's ratings, SKU's listing quality, SKU's price in comparison to competitors, and whether the SKU has a buy box. The fifth classifier may be trained based on the second feature set with higher weights on positive observations. The sixth classifier may be trained based on the second feature set with higher weights on negative observations.

In some embodiments, the second meta classifier comprises: a fourth aggregated classifier configured to compute a fourth aggregated sale probability for each SKU based on a weighted combination of the fourth sale probabilities of the fourth classifiers in the twelve monthly second stage models; a fifth aggregated classifier configured to compute a fifth aggregated sale probability for each SKU based on a weighted combination of the fifth sale probabilities of the fifth classifiers in the twelve monthly second stage models; a sixth aggregated classifier configured to compute a sixth aggregated sale probability for each SKU based on a weighted combination of the sixth sale probabilities of the sixth classifiers in the twelve monthly second stage models; a first model configured to compute a first probability based on a weighted combination of the fourth aggregated sale probability, the fifth aggregated sale probability and the sixth aggregated sale probability; a second model configured to compute a second probability based on a weighted combination of the fourth aggregated sale probability, the fifth aggregated sale probability and the sixth aggregated sale probability; a third model configured to compute a third probability based on a weighted combination of the fourth aggregated sale probability, the fifth aggregated sale probability and the sixth aggregated sale probability; and a second optimizer. The fourth aggregated classifier may be trained based on a portion of most important SKU features indicated by the fourth feature importance data. The fifth aggregated classifier may be trained based on a portion of most important SKU features indicated by the fifth feature importance data. The sixth aggregated classifier may be trained based on a portion of most important SKU features indicated by the sixth feature importance data. The first model may be trained based on features of observed items whose first stage probabilities are larger than a probability threshold. The second model may be trained based on features of observed items whose first stage probabilities are less than the probability threshold. The third model may be trained based on features of all observed items. The second optimizer may be configured to: determine, for each SKU, second weights for the first probability, the second probability, the third probability and the first stage probability for an item corresponding to the SKU; and compute a second stage probability for each SKU based on a weighted combination of the first probability, the second probability, the third probability and the first stage probability for the item corresponding to the SKU, with their respective second weights.

In some embodiments, the SKU recommendation engine 406 may generate a list of recommended SKUs, each of which has a second stage probably larger than a certain threshold, which means the SKUs are expected to have a good sale in the future time period. Both the item recommendation engine 404 and the SKU recommendation engine 406 can operate irrespective of any shopping event or any theme-specific campaign. The SKU recommendation engine 406 may then send the list of recommended SKUs to the campaign allocation engine 408 for campaign allocation.

In some embodiments, the campaign allocation engine 408 may perform an allocation of at least one of the plurality of item-seller combinations or SKUs to each of the at least one upcoming shopping event in the future time period. For example, the campaign allocation engine 408 can select a first subset of item-seller combinations, from the plurality of item-seller combinations, that are classified as eligible for each of the at least one upcoming shopping event; select a second subset of item-seller combinations, from the first subset of item-seller combinations, that have a price lower than a price threshold related to a competitor; select a third subset of item-seller combinations, from the second subset of item-seller combinations, that have top sale probabilities in the future time period including the at least one upcoming shopping event; select a fourth subset of item-seller combinations, from the third subset of item-seller combinations, that have features related to a theme of the at least one upcoming shopping event; and select a fifth subset of item-seller combinations, from the fourth subset of item-seller combinations, based on a seller-level optimization to ensure enough variability of recommended items, popular and opportunity categories across the plurality of sellers. In some embodiments, the campaign allocation engine 408 can select the at least one of the plurality of item-seller combinations, from the fifth subset of item-seller combinations, based on an overall optimization. The campaign allocation engine 408 may then send the allocated item-seller combinations to the recommendation optimization engine 410 for recommendation optimization.

The recommendation optimization engine 410 in this example may perform optimizations in terms of recent performance, reviews, ratings, and shipping speed, to generate, for each of the plurality of sellers, a customized list of items for each upcoming shopping event based on the allocation. In some embodiments, the recommendation optimization engine 410 may transmit the customized list of items as the item-seller recommendation 312 to the web server 104, and the web server 104 will show the customized list of items to each respective seller. In some embodiments, the recommendation optimization engine 410 may directly transmit, to a computing device of each of the plurality of sellers, the customized list of items for creating advertising campaigns associated with the at least one upcoming shopping event in the future time period.

In some embodiments, the future time period is next two weeks; while the customized list of items is generated weekly for each upcoming shopping event in the next two weeks. In some embodiments, the machine learning model(s) utilized by the campaign recommendation computing device 102 are trained every month based on: training each of the twelve monthly first stage models and the twelve monthly second stage models, based on its own preparation data set, which includes: training data set, validation data set, hold out data set, and test data set. Each preparation data set may be collected based on: collecting historical campaign data every week from previous advertising campaigns ended in a previous week; for each item in the previous advertising campaigns, determining, from the historical campaign data, sale performance of the item during a campaign period of the item, and generating features of the item based on historical data of the item prior to the campaign period of the item.

In some embodiments, every week, a campaign recommendation system can check all those campaigns that ended in the previous week irrespective of what campaigns they were, and prepare relevant data from those campaigns. Based on the relevant data, the system can obtain the performance of all items (irrespective of their part or role in any upcoming event) during a future event period. For each of these items, the system can look back at the respective event submission date, and generate features from the most recent 6 weeks prior to the item submission date. For each item, the system can have the seller level view of the item's performance prior to the item submission date, and its performance during the event. These past campaign data can be collected to build a machine learning model for recommending items to create campaigns.

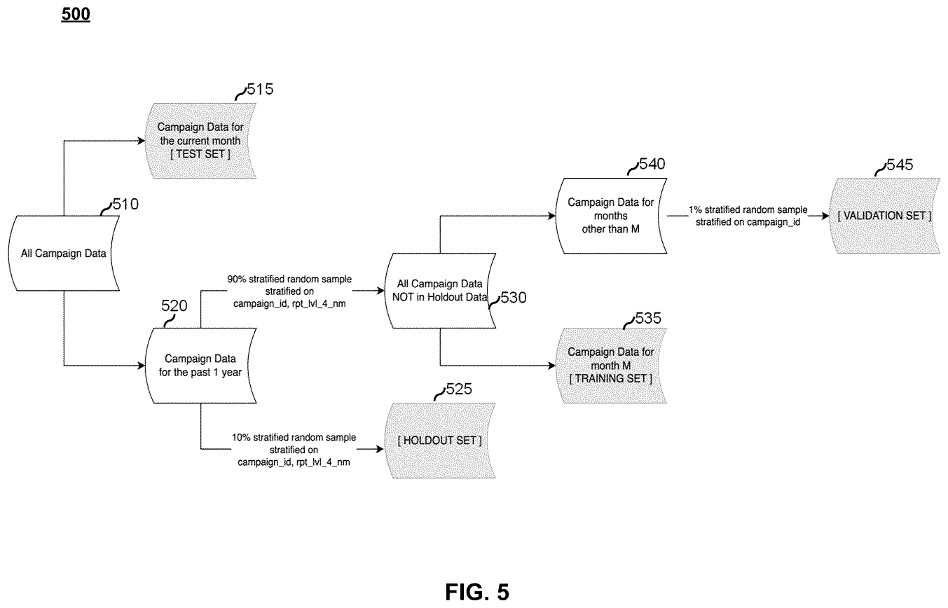

FIG. 5 illustrates a data architecture 500 for preparing data to build a machine learning model, in accordance with some embodiments of the present teaching. As shown in FIG. 5, the data architecture 500 identifies all campaign data 510, which includes a test data set 515 and a campaign data for the past one year 520. The test data set 515 includes campaign data for the current month, and will be used to test the machine learning model after the machine learning model is trained and validated.

As shown in FIG. 5, a 10% stratified random sample of past one year's campaign event data, which is stratified on campaign ID and item subcategory, is treated as a holdout data set 525. Since the samples are stratified, the holdout data set 525 has a representation from all of the campaigns and subcategories. The remaining stratified random sample of past one year's campaign event data is collected as “all campaign data not in holdout data” 530, which includes a training data set 535 and a remaining data set 540. The training data set 535 comprises campaign data for month M, which may be a same month during past one year as a future month for which the machine learning model is generated to recommend campaign items. In some embodiments, the training data set 535 comprises label data including performances of all items in those campaigns during the campaign period. The remaining data set 540 may comprise campaign data for months other than M. A 1% stratified random sample from the remaining data set 540 can be tread as a validation data set 545.

In some embodiments, a machine learning model, e.g. a monthly model 392 for month M, may be trained using the training data set 535, validated using the validation data set 545. In some embodiments, a meta-classifier 394 may be tuned based on the holdout data set 525. After all monthly models and classifiers are trained and tuned, the entire machine learning model may be tested using the test data set 515.

In some embodiments, a campaign agnostic model may be built in two stages. The first stage identifies items that are more likely to sell during any upcoming event, with their submission dates in the current month. The second stage tries to identify which sellers are most likely to do well, with respect to the identified items in the first stage. In some examples, the first stage and the second stage will be utilized by the item recommendation engine 404 and the SKU recommendation engine 406, respectively. In some examples, the campaign agnostic model is refreshed every month.

In some embodiments, if the first stage identifies that a certain item A is expected to do well during an upcoming event, the second stage determines which of the sellers selling the item A is more suited to benefit from the upcoming event. This can be determined based on features like the overall performance of the seller, the price the seller is willing to offer item A for, etc. After the two stages, a probability score may be generated for each seller-item combination to do well in the upcoming campaign or event.

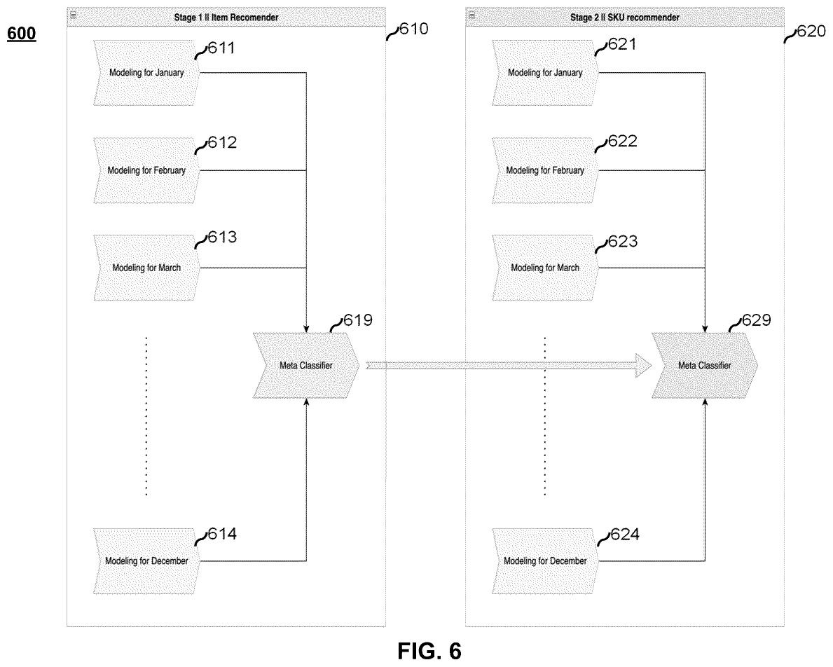

FIG. 6 illustrates an exemplary diagram of a recommendation model 600, which may be a campaign agnostic model utilized by e.g. the item recommendation engine 404 and the SKU recommendation engine 406 in FIG. 4, in accordance with some embodiments of the present teaching. As shown in FIG. 6, the recommendation model 600 may be built in two parts: a stage-1 item recommender model 610 and a stage-2 SKU recommender model 620. In some embodiments, the stage-1 item recommender model 610 and the stage-2 SKU recommender model 620 may be utilized by the item recommendation engine 404 and the SKU recommendation engine 406, respectively.

As shown in FIG. 6, the stage-1 item recommender model 610 includes a plurality of monthly models 611, 612, 613, 614, each for a month during past one year; and a meta classifier 619. The output of the stage-1 item recommender model 610 is a stage-1 probability of sale for each item during an event, given its performance in a period prior to the campaign's submission deadline. This item recommender stage considers features like the item's hierarchy, popularity in terms of ratings and reviews, its performance in terms of relative and absolute sales, returns, pageviews and other item related features. An item's hierarchy data may indicate different levels of hierarchical class or department the item belongs to, e.g. super division, division, category, subcategory, etc. In some embodiments, the meta classifier 619 generates the stage-1 probability which will be utilized by a meta classifier 629 in the stage-2 SKU recommender model 620.

As shown in FIG. 6, the stage-2 SKU recommender model 620 includes a plurality of monthly models 621, 622, 623, 624, each for a month during past one year; and the meta classifier 629. The output of the stage-2 SKU recommender model 620 is a stage-2 probability of sale for each SKU (or called offer or item-seller combination) during an event, given its performance in the period prior to the campaign's submission deadline. The stage-1 probability from the stage-1 item recommender model 610 (or the meta classifier 619) is also considered as an input to the stage-2 SKU recommender model 620. In addition to the stage-1 probability, the stage-2 SKU recommender model 620 also considers other features including: corresponding seller's performance in terms of on-time delivery rate, seller's ratings, SKU's relative performance in terms of sales, returns and cancellations, SKU's listing quality, and its pricing in comparison to competitors, whether it has a buy box or not, etc. An SKU's listing quality may be determined based on a score computed for a listing of the SKU, based on descriptions and figures of the SKU, reviews and rating of the SKU, price of the SKU compared to similar items, how fast it gets delivered, etc. While a same item may be sold by multiple sellers, one of the sellers holds the buy box which a buyer can directly click on the description webpage of the item, and the other sellers may be aggregated under a link in the description webpage. For example, a seller having a higher listing quality and a lower price may get the buy box.

In some embodiments, each of the two stages follows a similar modeling structure, albeit with different sets of features. As shown in FIG. 6, based on a K-fold cross validation technique, a same model is trained on 12 monthly folds of data, each fold having its own training, validation and holdout datasets. This can help in gathering information from all the events that took place over last one year, with each month's event independent of the other months. All monthly models are tied back together under the meta-classifier, which gives optimal weights to each model to generate a corresponding stage probability output.

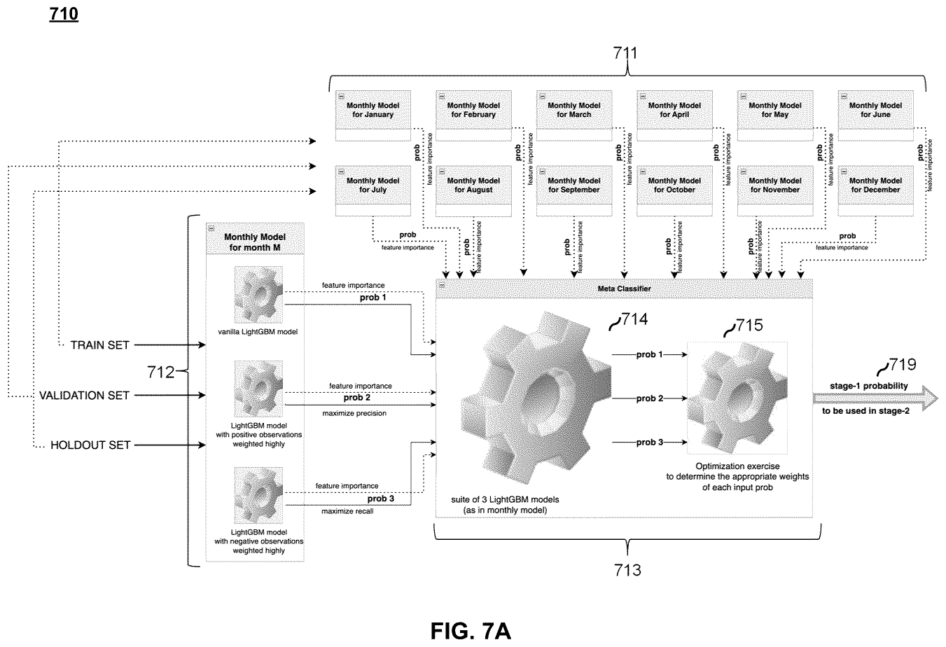

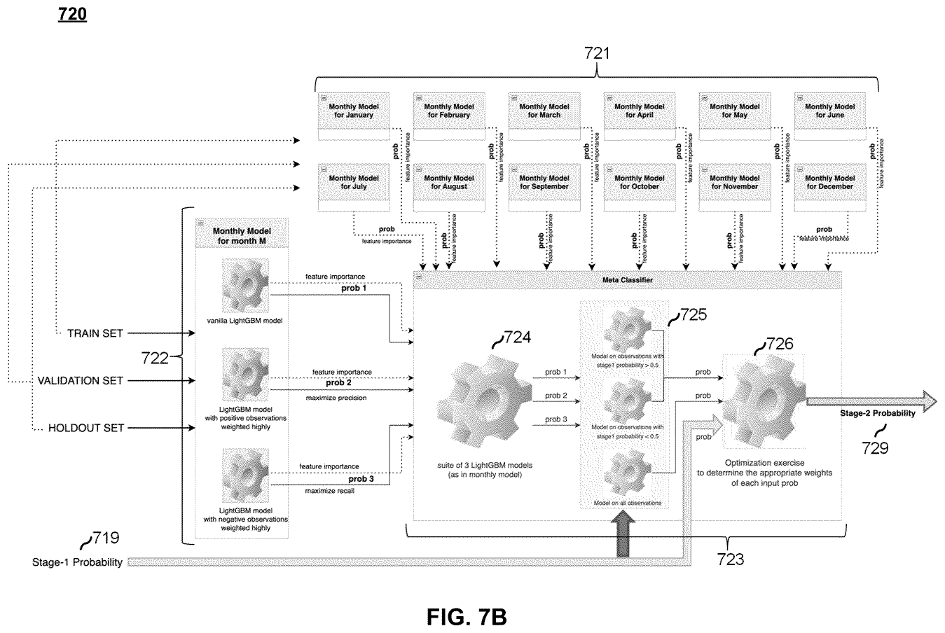

FIG. 7A illustrates an exemplary detailed architecture of a stage-1 recommendation model 710, which may be the stage-1 item recommender model 610 that can be utilized by the item recommendation engine 404, in accordance with some embodiments of the present teaching. The output of the stage-1 recommendation model 710 is a stage-1 probability 719, which is a probability of an item to do well in an upcoming event.

As shown in FIG. 7A, the stage-1 recommendation model 710 includes 12 monthly models 711, each for a respective month during a year; and a meta classifier 713. In the example shown in FIG. 7A, each monthly model in turn has a suite of three models or classifiers 712 being trained on a same first feature set. The three models 712 include: a Light Gradient-Boosting Machine (GBM) model, a LightGBM model with higher weights on positive observations to maximize precision rate, and a LightGBM model with higher weights on negative observations to maximize recall rate. Positive observations include items that refer to the success class of being sold in the training data e.g. sold more than a pre-specified number of units; while negative observations include items that refer to the failure class of being sold in the training data, e.g. not sold or sold less than a pre-specified number of units. A higher weight on positive observations means oversample on the positive observations and under sample on the negative observations, to get more representations from items that are sold well. In contrast, a higher weight on negative observations means oversample on the negative observations and under sample on the positive observations, to get more representations from items that are not sold well. A precision rate is a rate of items being sold well and being recommended, among all items that are recommended. A recall rate is a rate of items being sold well and being recommended, among all items that were actually sold well in reality.

As such, the stage-1 recommendation model 710 includes in total 36 LightGBM models, each generating a probability indicating how likely an item will have a good sale in the future time period, as well as feature importance data indicating importance of different features for contributing to the generated probability. Each of these probabilities, along with a respective feature importance, is passed onto the meta classifier 713 for identification of optimal weights.

In FIG. 7A, the top boxes for each month represent each monthly model, while a magnified view of a representative monthly model is provided on the left of FIG. 7A.

In some embodiments, the meta classifier 713 firstly trains a suite of three aggregated LightGBM models 714, which may have the same structure as the three LightGBM models 712 in each monthly model respectively, but based on the top most important (e.g. top 10%) aggregated features from the monthly models 711 along with the respective probabilities. These three probabilities generated by the three aggregated LightGBM models 714 are passed through an optimizer 715 to identify the optimal weights that maximizes an F-score of the stage-1 recommendation model 710. For example, the stage-1 recommendation model 710 may be trained iteratively based on training data until the F-score cannot be improved by more than a threshold, e.g. 1%. Based on the optimal weights, the optimizer 715 outputs a stage-1 probability 719 based on a weighted combination, e.g. a weight summation, of the three probabilities generated by the three aggregated LightGBM models 714. The stage-1 probability 719 will be utilized during a stage-2.

In some embodiments, all of the models and classifiers in the stage-1 recommendation model 710 are trained together iteratively to maximize the F-score of the stage-1 recommendation model 710. For example, all of the weights, including the weights to combine the monthly models 711 to generate the three aggregated LightGBM models 714, and the weights to combine probabilities from the three aggregated LightGBM models 714 by the optimizer 715, and all of the hyperparameters including the tree parameters in the monthly models 711, are tuned iteratively over training, holdout and validation data, until the F-score cannot be improved by more than a threshold, e.g. 1%.

FIG. 7B illustrates an exemplary detailed architecture of a stage-2 recommendation model 720, which may be the stage-2 SKU recommender model 620 that can be utilized by the SKU recommendation engine 406, in accordance with some embodiments of the present teaching. The output of the stage-2 recommendation model 720 is a stage-1 probability 729, which is a probability of a SKU to do well in an upcoming event. The stage-1 probability 729 is computed based on the stage-1 probability 719, along with other features.

Similar to the stage-1 recommendation model 710, the stage-2 recommendation model 720 includes 12 monthly models 721, each for a respective month during a year; and a meta classifier 723. In the example shown in FIG. 7B, each monthly model in turn has a suite of three models 722 being trained on a same second feature set. The three models 722 include: a Light Gradient-Boosting Machine (GBM) model, a LightGBM model with higher weights on positive observations to maximize precision rate, and a LightGBM model with higher weights on negative observations to maximize recall rate. In some embodiments, the monthly models 721 each including the three models 722 are the same as the monthly models 711 each including the three models 712, but are trained using different features. While the monthly models 711 each including the three models 712 are trained based on item level features, the monthly models 721 each including the three models 722 are trained based on SKU level features.

As such, the stage-2 recommendation model 720 includes in total 36 LightGBM models, each generating a probability indicating how likely an SKU will have a good sale in the future time period, as well as feature importance data indicating importance of different features for contributing to the generated probability. Each of these probabilities, along with a respective feature importance, is passed onto the meta classifier 723 for identification of optimal weights.

While the first feature set for the stage-1 recommendation model 710 includes features about items, the second first feature set for the stage-2 recommendation model 720 includes features about SKUs, e.g. the corresponding seller's performance in terms of on-time delivery rate, seller's ratings, SKU's relative performance in terms of sales, returns and cancellations, SKU's listing quality, and its pricing in comparison to competitors, whether it has a buy box or not, etc. In FIG. 7B, the top boxes for each month represent each monthly model, while a magnified view of a representative monthly model is provided on the left of FIG. 7B.

Similar to the meta classifier 713, the meta classifier 723 firstly trains a suite of three aggregated LightGBM models 724, which may have the same structure as the three LightGBM models 722 in each monthly model respectively, but based on the top most important (e.g. top 10%) aggregated features from the monthly models 721 along with the respective probabilities. These three probabilities generated by the three aggregated LightGBM models 724 are then utilized to generate three new classifiers or models 725 that are trained on the stage-1 probability 719. The three new models 725 includes: a first model trained on those items which have a high stage-1 probability, e.g. higher than 0.5; a second model trained on those items which have a low stage-1 probability, e.g. lower than 0.5; and a third model trained on full data including all observations irrespective of their stage-1 probability. The probabilities generated by the three new models 725, along with the stage-1 probability 719, are passed through an optimizer 726 to identify the optimal weights that maximizes an F-score of the stage-2 recommendation model 720. Based on the optimal weights, the optimizer 726 outputs a stage-2 probability 729 based on a weighted combination, e.g. a weight summation, of the probabilities generated by the three new models 725 and the stage-1 probability 719. In some embodiments, the probabilities generated by the first model and the second model are aggregated together to generate an aggregated probability. The optimal weights computed by the optimizer 726 include a first weight for the aggregated probability, a second weight for a probability generated by the third model, and a third weight for the stage-1 probability 719.

In some embodiments, all of the models and classifiers in the stage-2 recommendation model 720 are trained together iteratively to maximize the F-score of the stage-2 recommendation model 720. For example, all of the weights, including the weights to combine the monthly models 721 to generate the three aggregated LightGBM models 724, the weights to combine probabilities from the three aggregated LightGBM models 724 by the three new models 725, and the weights utilized by the optimizer 726, and all of the hyperparameters including the tree parameters in the monthly models 721, are tuned iteratively over training, holdout and validation data, until the F-score cannot be improved by more than a threshold, e.g. 1%.

After the machine learning model including the stage-1 recommendation model 710 and the stage-2 recommendation model 720 is trained (and updated every month), the machine learning model can be used to recommend SKUs without knowledge of what kind of campaign or event for which the SKUs are recommended. In some embodiments, a list of SKUs can be selected based on their stage-2 probabilities, e.g. when their stage-2 probabilities are higher than a certain threshold. This list of SKUs are generated without using knowledge of a specific campaign or event in the future time period.

In some embodiments, every week, a campaign recommendation system can generate recommendations for events having submission deadlines in the next two weeks. This is a stage where campaign specific recommendations are generated, based on the list of SKUs generated using a campaign agnostic model. In some embodiments, the campaign specific recommendations are generated based on campaign allocation and recommendation optimization.

For campaign allocation, the system can consider all the items recommended by the campaign agnostic model, and try to allocate them to each of the eligible events, e.g. events which have a submission deadline in the next 2 weeks. This may be performed using event specific features like: event duration and timeline, seasonality of the items over the weeks, and eligible categories for special-theme based events.

The campaign allocation provides an initial set of recommendations at a campaign level. Then, one or more optimizations can be performed on the initial set of recommendations based on pre-defined constraints, to customize the recommendations and minimize their rejection likelihood by the retailer. The optimizations can be based on: spreading across sellers the popular and opportunity categories; maintaining enough variability in the recommendations, such that all sellers do not get similar recommended items; maintaining high quality of recommended items in terms of recent performance, reviews, ratings, shipping speed etc.; and maintaining competitive pricing of the recommended items.

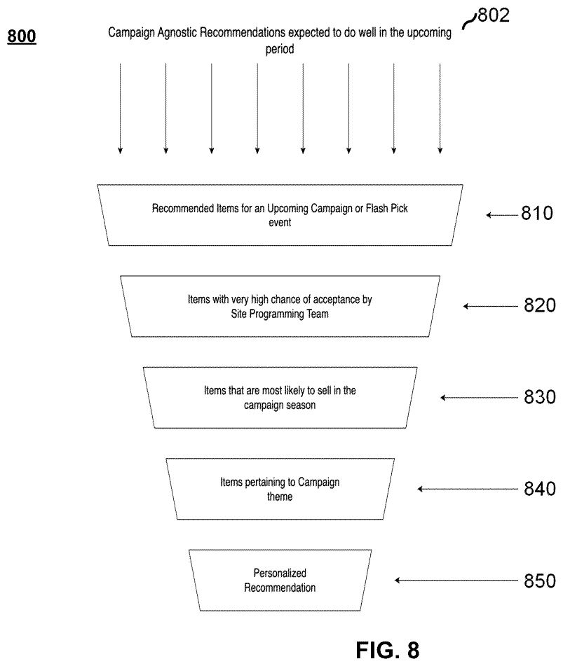

FIG. 8 illustrates a process 800 for campaign allocation, in accordance with some embodiments of the present teaching. In some embodiments, the process 800 can be carried out by one or more computing devices, such as the campaign recommendation computing device 102 and/or the cloud-based engine 121 of FIG. 1.

As shown in FIG. 8, the process 800 starts with campaign agnostic recommendations 802, which are expected to do well in an upcoming time period based on a campaign agnostic model. At operation 810, a binary classification may be performed to select recommended items for an upcoming campaign or event, from the campaign agnostic recommendations 802. For example, if an item has a sale probability larger than a threshold, it is classified as one; if the item has a sale probability lower than the threshold, it is classified as zero. At operation 820, some rejection filters may be applied to further select items with high change of acceptance by a site programming team of the retailer, among the recommended items from the operation 810. The rejection filters may consider the items' listing quality, price compared to competitors, etc. Then at operation 830, some seasonal index may be utilized to further select items that are most likely to sell in each campaign season, among the recommended items from the operation 820. Then at operation 840, some event-theme based filter may be applied to further select items pertaining to a specific campaign theme of each event, among the recommended items from the operation 830. At operation 850, a personalized recommendation is generated for each seller, based on some optimizations on the recommended items from the operation 840. In some examples, the optimizations include a seller level optimization based on each seller's profile and feature. In some examples, the optimizations also include other optimizations based on each seller's performance, reviews, ratings, shipping speed etc.

During campaign allocation, it is possible that a same item or SKU is recommended to multiple campaigns. At the end of campaign allocation, a customized list of items is recommended to each seller interested in submitting items to create an upcoming campaign, such that different sellers do not see the same recommendations. In addition, the recommendations each seller receives will be personalized and diversified across the seller's assortment. A shoe seller may receive not only recommendations about shoes, but also recommendations like socks, shoe polish, etc.

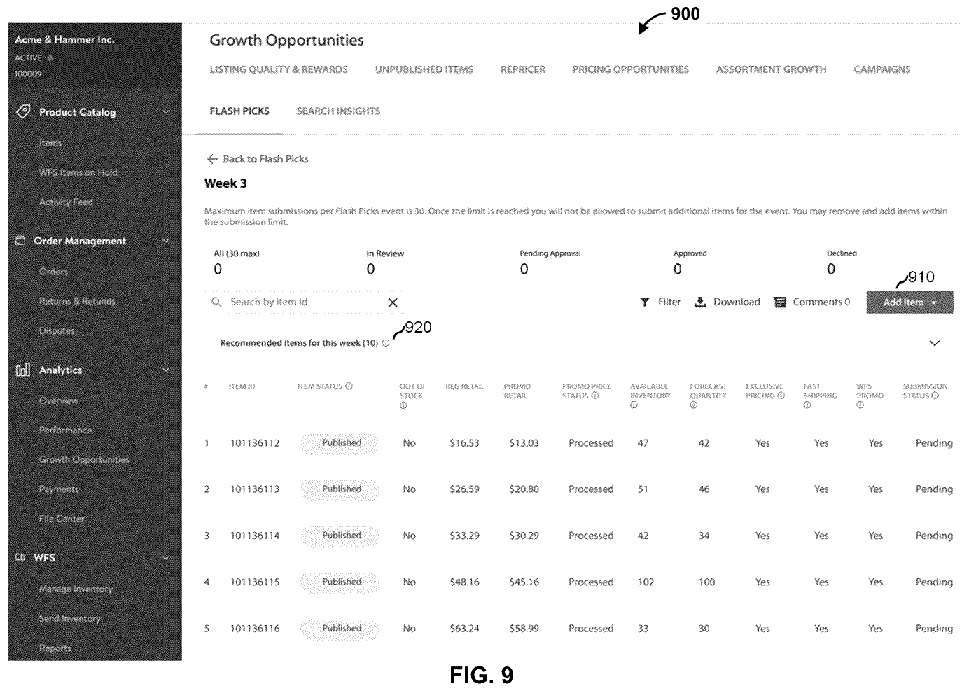

FIG. 9 illustrates an exemplary user interface 900 to create advertising campaigns, in accordance with some embodiments of the present teaching. As shown in FIG. 9, the user interface 900 provides components for a seller to create advertising campaigns for an upcoming week (Week 3) including a Flash Pick discount event on a retailer's website. By clicking on an “Add Item” button 910, the seller can add items from the seller's assortment to an advertising campaign set for the upcoming week. In this example, the system has recommended items 920 for this upcoming week to the seller. These recommended items 920 may be generated based on the above methods and systems discussed referring to FIGS. 1-8.

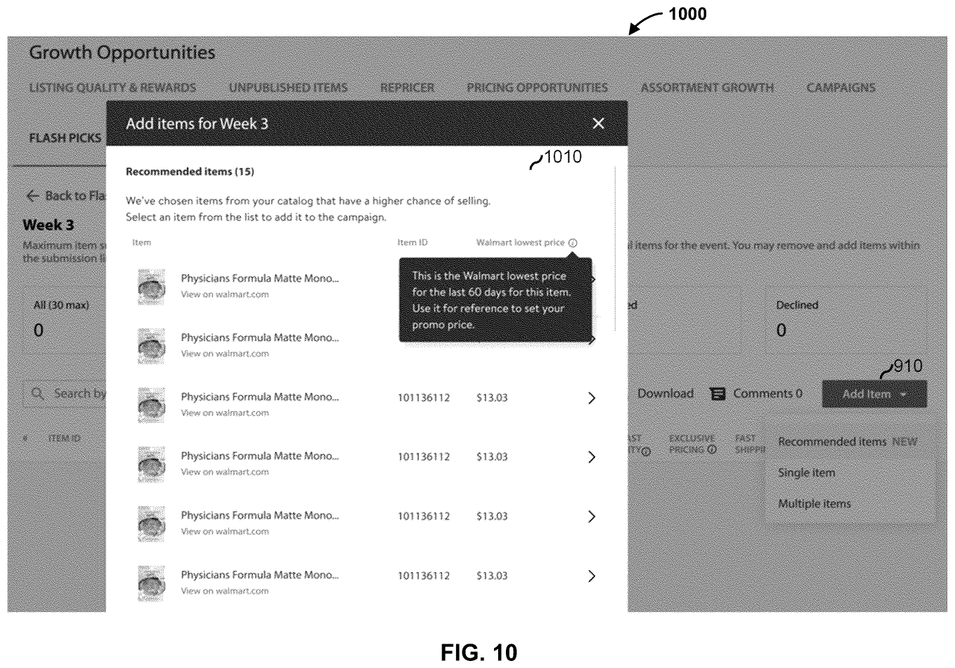

FIG. 10 illustrates an exemplary user interface 1000 for recommending items to create advertising campaigns, in accordance with some embodiments of the present teaching. As shown in FIG. 10, the user interface 1000 shows a pop-up window 1010 listing recommended items to a seller, after the seller clicks on the “Add Item” button 910 and selects “Recommended items” from a drop-down list shown below the “Add Item” button 910. The recommended items listed in the pop-up window 1010 are chosen by the system from the seller's catalog, and determined to have a higher chance of selling in the upcoming week, e.g. based on the above methods and systems discussed referring to FIGS. 1-8. For each recommended item, a lowest price for the last 60 days for the item on the retailer's website is shown in the pop-up window 1010 as a reference for the seller to set up a promotion price in the upcoming campaign. After the seller selects one or more items, the seller can submit them for the upcoming campaign with promotion prices.

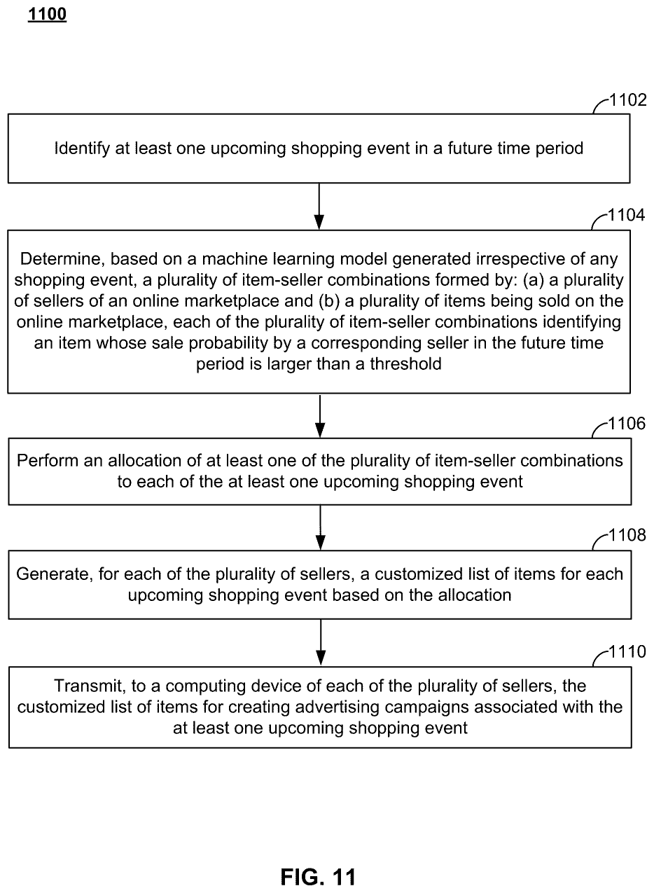

FIG. 11 is a flowchart illustrating an exemplary method 1100 for recommending items to create advertising campaigns for upcoming events, in accordance with some embodiments of the present teaching. In some embodiments, the method 1100 can be carried out by one or more computing devices, such as the campaign recommendation computing device 102 and/or the cloud-based engine 121 of FIG. 1. Beginning at operation 1102, at least one upcoming shopping event is identified in a future time period. At operation 1104, based on a machine learning model generated irrespective of any shopping event, a plurality of item-seller combinations is determined and formed by: (a) a plurality of sellers of an online marketplace and (b) a plurality of items being sold on the online marketplace. Each of the plurality of item-seller combinations identifies an item whose sale probability by a corresponding seller in the future time period is larger than a threshold. At operation 1106, an allocation is performed to allocate at least one of the plurality of item-seller combinations to each of the at least one upcoming shopping event. For each of the plurality of sellers, a customized list of items is generated at operation 1108 for each upcoming shopping event based on the allocation. The customized list of items is transmitted at operation 1110 to a computing device of each of the plurality of sellers, for creating advertising campaigns associated with the at least one upcoming shopping event.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

1. A system, comprising:
a non-transitory memory having instructions stored thereon; and
at least one processor operatively coupled to the non-transitory memory, and configured to read the instructions to:
identify at least one upcoming shopping event,
determine, based on a machine learning model generated irrespective of any shopping event, a plurality of item-seller combinations, wherein each of the plurality of item-seller combinations is formed by a respective item and a respective seller such that a sale probability of successfully selling the respective item by the respective seller in a future time period is larger than a threshold,
perform an allocation of at least one of the item-seller combinations to the at least one upcoming shopping event,
generate, in response to a real-time request from for a seller, a customized list of items associated with the at least one upcoming shopping event based on the allocation, and
transmit the customized list of items for the seller to create an advertising campaign.

2. The system of claim 1, wherein:
the machine learning model comprises a first stage model and a second stage model;
the first stage model comprises twelve monthly first stage models and a first meta classifier; and
the second stage model comprises twelve monthly second stage models and a second meta classifier.

3. The system of claim 2, wherein the plurality of item-seller combinations are determined based on:
determining, based on the first stage model, items whose sale probability is larger than a first threshold in the future time period, and
determining, based on the second stage model for each of the determined items, at least one seller who is expected to sell the item with a probability larger than a second threshold in the future time period.

4. The system of claim 2, wherein:
each of the twelve monthly first stage models is configured to:
compute a first sale probability for each item based on a first feature set, wherein the first feature set comprises at least some of the following features related to each item: the item's hierarchy, ratings, reviews, relative sales performance, absolute sales performance, return rates, and pageviews, and
determine first feature importance data associated with features in the first feature set; and
the first meta classifier is configured to:
determine, for each item, first weights for the twelve monthly first stage models, based on their respective first sale probabilities and their respective first feature importance data, and
compute a first stage probability for each item based on a weighted combination of the first sale probabilities of the twelve monthly first stage models, with their respective first weights.

5. The system of claim 4, wherein:
each of the twelve monthly second stage models is configured to:
compute, based on a second feature set, a second sale probability for each stock keeping unit (SKU) corresponding to an item-seller combination, wherein the second feature set comprises at least some of the following features related to each SKU: hierarchy, ratings, reviews, relative sales performance, absolute sales performance, returns, cancellations, pageviews, seller's on-time delivery rate, seller's ratings, SKU's listing quality, SKU's price in comparison to competitors, and whether the SKU has a buy box, and
determine second feature importance data associated with features in the second feature set; and
the second meta classifier is configured to:
determine, for each SKU, second weights for the twelve monthly second stage models, based on their respective second sale probabilities and their respective second feature importance data, and
compute a second stage probability for each SKU based on a combination of: (a) the first stage probability for an item corresponding to the SKU, and (b) a weighted combination of the second sale probabilities of the twelve monthly second stage models with their respective second weights.

6. The system of claim 3, wherein:
each of the twelve monthly first stage models comprises:
a first classifier configured to compute a first sale probability for each item based on first feature importance data associated with features of the item, wherein the first classifier is trained based on a first feature set that comprises at least some of the following features related to each item: the item's hierarchy, ratings, reviews, relative sales performance, absolute sales performance, return rates, and pageviews,
a second classifier configured to compute a second sale probability for each item based on second feature importance data associated with features of the item, wherein the second classifier is trained based on the first feature set with higher weights on positive observations, and
a third classifier configured to compute a third sale probability for each item based on third feature importance data associated with features of the item, wherein the third classifier is trained based on the first feature set with higher weights on negative observations; and
the first meta classifier comprises:
a first aggregated classifier configured to compute a first aggregated sale probability for each item based on a weighted combination of the first sale probabilities of the first classifiers in the twelve monthly first stage models, wherein the first aggregated classifier is trained based on a portion of most important item features indicated by the first feature importance data,
a second aggregated classifier configured to compute a second aggregated sale probability for each item based on a weighted combination of the second sale probabilities of the second classifiers in the twelve monthly first stage models, wherein the second aggregated classifier is trained based on a portion of most important item features indicated by the second feature importance data,
a third aggregated classifier configured to compute a third aggregated sale probability for each item based on a weighted combination of the third sale probabilities of the third classifiers in the twelve monthly first stage models, wherein the third aggregated classifier is trained based on a portion of most important item features indicated by the third feature importance data, and
a first optimizer configured to
determine, for each item, first weights for the first aggregated sale probability, the second aggregated sale probability and the third aggregated sale probability, and
compute a first stage probability for each item based on a weighted combination of the first aggregated sale probability, the second aggregated sale probability and the third aggregated sale probability, with their respective first weights.

7. The system of claim 6, wherein the first weights maximize an F-score that is computed based on a combination of a precision rate and a recall rate of item sale prediction.

8. The system of claim 6, wherein each of the twelve monthly second stage models comprises:
a fourth classifier configured to compute a fourth sale probability for each stock keeping unit (SKU) corresponding to an item-seller combination based on fourth feature importance data associated with features of the SKU, wherein the fourth classifier is trained based on a second feature set that comprises at least some of the following features related to each SKU: hierarchy, ratings, reviews, relative sales performance, absolute sales performance, returns, cancellations, pageviews, seller's on-time delivery rate, seller's ratings, SKU's listing quality, SKU's price in comparison to competitors, and whether the SKU has a buy box;
a fifth classifier configured to compute a fifth sale probability for each SKU based on fifth feature importance data associated with features of the SKU, wherein the fifth classifier is trained based on the second feature set with higher weights on positive observations; and
a sixth classifier configured to compute a sixth sale probability for each SKU based on sixth feature importance data associated with features of the SKU, wherein the sixth classifier is trained based on the second feature set with higher weights on negative observations.

9. The system of claim 8, wherein the second meta classifier comprises:
a fourth aggregated classifier configured to compute a fourth aggregated sale probability for each SKU based on a weighted combination of the fourth sale probabilities of the fourth classifiers in the twelve monthly second stage models, wherein the fourth aggregated classifier is trained based on a portion of most important SKU features indicated by the fourth feature importance data,
a fifth aggregated classifier configured to compute a fifth aggregated sale probability for each SKU based on a weighted combination of the fifth sale probabilities of the fifth classifiers in the twelve monthly second stage models, wherein the fifth aggregated classifier is trained based on a portion of most important SKU features indicated by the fifth feature importance data,
a sixth aggregated classifier configured to compute a sixth aggregated sale probability for each SKU based on a weighted combination of the sixth sale probabilities of the sixth classifiers in the twelve monthly second stage models, wherein the sixth aggregated classifier is trained based on a portion of most important SKU features indicated by the sixth feature importance data,
a first model configured to compute a first probability based on a weighted combination of the fourth aggregated sale probability, the fifth aggregated sale probability and the sixth aggregated sale probability, wherein the first model is trained based on features of observed items whose first stage probabilities are larger than a probability threshold,
a second model configured to compute a second probability based on a weighted combination of the fourth aggregated sale probability, the fifth aggregated sale probability and the sixth aggregated sale probability, wherein the second model is trained based on features of observed items whose first stage probabilities are less than the probability threshold,
a third model configured to compute a third probability based on a weighted combination of the fourth aggregated sale probability, the fifth aggregated sale probability and the sixth aggregated sale probability, wherein the third model is trained based on features of all observed items, and
a second optimizer configured to:
determine, for each SKU, second weights for the first probability, the second probability, the third probability and the first stage probability for an item corresponding to the SKU, and
compute a second stage probability for each SKU based on a weighted combination of the first probability, the second probability, the third probability and the first stage probability for the item corresponding to the SKU, with their respective second weights.

10. The system of claim 1, wherein:
the customized list of items is generated weekly for each upcoming shopping event in next two weeks;
the machine learning model is trained every month based on: training each of the twelve monthly first stage models and the twelve monthly second stage models, based on its own preparation data set, which includes: training data set, validation data set, hold out data set, and test data set; and
each preparation data set is collected based on:
collecting historical campaign data every week from previous advertising campaigns ended in a previous week,
for each item in the previous advertising campaigns,
determining, from the historical campaign data, sale performance of the item during a campaign period of the item, and
generating features of the item based on historical data of the item prior to the campaign period of the item.

11. The system of claim 1, wherein the allocation is performed based on:
selecting a first subset of item-seller combinations, from the plurality of item-seller combinations, that are classified as eligible for each of the at least one upcoming shopping event;
selecting a second subset of item-seller combinations, from the first subset of item-seller combinations, that have a price lower than a price threshold related to a competitor;
selecting a third subset of item-seller combinations, from the second subset of item-seller combinations, that have top sale probabilities in a future time period including the at least one upcoming shopping event;
selecting a fourth subset of item-seller combinations, from the third subset of item-seller combinations, that have features related to a theme of the at least one upcoming shopping event; and
selecting a fifth subset of item-seller combinations, from the fourth subset of item-seller combinations, based on a seller-level optimization to ensure enough variability of recommended items, popular and opportunity categories across the plurality of sellers.

12. The system of claim 11, wherein the allocation is performed based on:
selecting the at least one of the plurality of item-seller combinations, from the fifth subset of item-seller combinations, based on an overall optimization in terms of recent performance, reviews, ratings, and shipping speed.

13. A computer-implemented method, comprising:
identifying at least one upcoming shopping event;
determining, based on a machine learning model generated irrespective of any shopping event, a plurality of item-seller combinations, wherein each of the plurality of item-seller combinations is formed by a respective item and a respective seller such that a sale probability of successfully selling the respective item by the respective seller in a future time period is larger than a threshold;
performing an allocation of at least one of the item-seller combinations to the at least one upcoming shopping event;
generating, in response to a real-time request from a seller, a customized list of items associated with the at least one upcoming shopping event based on the allocation; and
transmitting the customized list of items for the seller to create an advertising campaign.

14. The computer-implemented method of claim 13, wherein:
the machine learning model comprises a first stage model and a second stage model;
the first stage model comprises twelve monthly first stage models and a first meta classifier; and
the second stage model comprises twelve monthly second stage models and a second meta classifier.

15. The computer-implemented method of claim 14, wherein:
each of the twelve monthly first stage models comprises:
a first classifier configured to compute a first sale probability for each item based on first feature importance data associated with features of the item, wherein the first classifier is trained based on a first feature set that comprises at least some of the following features related to each item: the item's hierarchy, ratings, reviews, relative sales performance, absolute sales performance, return rates, and pageviews,
a second classifier configured to compute a second sale probability for each item based on second feature importance data associated with features of the item, wherein the second classifier is trained based on the first feature set with higher weights on positive observations, and
a third classifier configured to compute a third sale probability for each item based on third feature importance data associated with features of the item, wherein the third classifier is trained based on the first feature set with higher weights on negative observations; and
the first meta classifier comprises:
a first aggregated classifier configured to compute a first aggregated sale probability for each item based on a weighted combination of the first sale probabilities of the first classifiers in the twelve monthly first stage models, wherein the first aggregated classifier is trained based on a portion of most important item features indicated by the first feature importance data,
a second aggregated classifier configured to compute a second aggregated sale probability for each item based on a weighted combination of the second sale probabilities of the second classifiers in the twelve monthly first stage models, wherein the second aggregated classifier is trained based on a portion of most important item features indicated by the second feature importance data,
a third aggregated classifier configured to compute a third aggregated sale probability for each item based on a weighted combination of the third sale probabilities of the third classifiers in the twelve monthly first stage models, wherein the third aggregated classifier is trained based on a portion of most important item features indicated by the third feature importance data, and
a first optimizer configured to
determine, for each item, first weights for the first aggregated sale probability, the second aggregated sale probability and the third aggregated sale probability, and
compute a first stage probability for each item based on a weighted combination of the first aggregated sale probability, the second aggregated sale probability and the third aggregated sale probability, with their respective first weights.

16. The computer-implemented method of claim 15, wherein each of the twelve monthly second stage models comprises:
a fourth classifier configured to compute a fourth sale probability for each stock keeping unit (SKU) corresponding to an item-seller combination based on fourth feature importance data associated with features of the SKU, wherein the fourth classifier is trained based on a second feature set that comprises at least some of the following features related to each SKU: hierarchy, ratings, reviews, relative sales performance, absolute sales performance, returns, cancellations, pageviews, seller's on-time delivery rate, seller's ratings, SKU's listing quality, SKU's price in comparison to competitors, and whether the SKU has a buy box;
a fifth classifier configured to compute a fifth sale probability for each SKU based on fifth feature importance data associated with features of the SKU, wherein the fifth classifier is trained based on the second feature set with higher weights on positive observations; and
a sixth classifier configured to compute a sixth sale probability for each SKU based on sixth feature importance data associated with features of the SKU, wherein the sixth classifier is trained based on the second feature set with higher weights on negative observations.

17. The computer-implemented method of claim 16, wherein the second meta classifier comprises:
a fourth aggregated classifier configured to compute a fourth aggregated sale probability for each SKU based on a weighted combination of the fourth sale probabilities of the fourth classifiers in the twelve monthly second stage models, wherein the fourth aggregated classifier is trained based on a portion of most important SKU features indicated by the fourth feature importance data,
a fifth aggregated classifier configured to compute a fifth aggregated sale probability for each SKU based on a weighted combination of the fifth sale probabilities of the fifth classifiers in the twelve monthly second stage models, wherein the fifth aggregated classifier is trained based on a portion of most important SKU features indicated by the fifth feature importance data,
a sixth aggregated classifier configured to compute a sixth aggregated sale probability for each SKU based on a weighted combination of the sixth sale probabilities of the sixth classifiers in the twelve monthly second stage models, wherein the sixth aggregated classifier is trained based on a portion of most important SKU features indicated by the sixth feature importance data,
a first model configured to compute a first probability based on a weighted combination of the fourth aggregated sale probability, the fifth aggregated sale probability and the sixth aggregated sale probability, wherein the first model is trained based on features of observed items whose first stage probabilities are larger than a probability threshold,
a second model configured to compute a second probability based on a weighted combination of the fourth aggregated sale probability, the fifth aggregated sale probability and the sixth aggregated sale probability, wherein the second model is trained based on features of observed items whose first stage probabilities are less than the probability threshold,
a third model configured to compute a third probability based on a weighted combination of the fourth aggregated sale probability, the fifth aggregated sale probability and the sixth aggregated sale probability, wherein the third model is trained based on features of all observed items, and
a second optimizer configured to:
determine, for each SKU, second weights for the first probability, the second probability, the third probability and the first stage probability for an item corresponding to the SKU, and
compute a second stage probability for each SKU based on a weighted combination of the first probability, the second probability, the third probability and the first stage probability for the item corresponding to the SKU, with their respective second weights.

18. The computer-implemented method of claim 13, wherein:
the customized list of items is generated weekly for each upcoming shopping event in next two weeks;
the machine learning model is trained every month based on: training each of the twelve monthly first stage models and the twelve monthly second stage models, based on its own preparation data set, which includes: training data set, validation data set, hold out data set, and test data set; and
each preparation data set is collected based on:
collecting historical campaign data every week from previous advertising campaigns ended in a previous week,
for each item in the previous advertising campaigns,
determining, from the historical campaign data, sale performance of the item during a campaign period of the item, and
generating features of the item based on historical data of the item prior to the campaign period of the item.

19. The computer-implemented method of claim 13, wherein performing the allocation comprises:
selecting a first subset of item-seller combinations, from the plurality of item-seller combinations, that are classified as eligible for each of the at least one upcoming shopping event;
selecting a second subset of item-seller combinations, from the first subset of item-seller combinations, that have a price lower than a price threshold related to a competitor;
selecting a third subset of item-seller combinations, from the second subset of item-seller combinations, that have top sale probabilities in a future time period including the at least one upcoming shopping event;
selecting a fourth subset of item-seller combinations, from the third subset of item-seller combinations, that have features related to a theme of the at least one upcoming shopping event;
selecting a fifth subset of item-seller combinations, from the fourth subset of item-seller combinations, based on a seller-level optimization to ensure enough variability of recommended items, popular and opportunity categories across the plurality of sellers; and
selecting the at least one of the plurality of item-seller combinations, from the fifth subset of item-seller combinations, based on an overall optimization in terms of recent performance, reviews, ratings, and shipping speed.

20. A non-transitory computer readable medium having instructions stored thereon, wherein the instructions, when executed by at least one processor, cause at least one device to perform operations comprising:
identifying at least one upcoming shopping event;
determining, based on a machine learning model generated irrespective of any shopping event, a plurality of item-seller combinations, wherein each of the plurality of item-seller combinations is formed by a respective item and a respective seller such that a sale probability of successfully selling the respective item by the respective seller in a future time period is larger than a threshold;
performing an allocation of at least one of the item-seller combinations to the at least one upcoming shopping event;
generating, in response to a real-time request from a seller, a customized list of items associated with the at least one upcoming shopping event based on the allocation; and
transmitting the customized list of items for the seller to create an advertising campaign.
